(19) United States
(12) Patent Application Publication
(10) Pub. No.: US 2006/0040703 A1
(43) Pub. Date: Feb. 23, 2006

(54) Mobile phone with a stereo recording function

(75) Inventors: Cheng-Shing Lai, Taipei (TW); Jing Liu, Nankng (CN); Hong-Yu Duan, Nankng (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/167,086

(22) Filed: Jun. 28, 2005

(30) Foreign Application Priority Data
Aug. 19, 2004 (TW) 093213225

(51) Int. Cl. H04M 1/00

(52) U.S. Cl. 455/556.1

(57) ABSTRACT

The present invention relates to a mobile phone with a stereo recording function, which includes a stereo sound frequency receiving module including sound receiving components for receiving sounds from different places within a sound field and converting the received sounds into a digital signal, a central processing unit (CPU) for encoding and compressing the digital signal, and a storage unit for storing the digital signal therein as an audio file having a stereo effect during being played back by the mobile phone.

### FIELD OF THE INVENTION

The present invention generally relates to mobile phones, more particularly to a mobile phone with a stereo recording function for recording sounds from different positions within a sound field to form an audio file having a stereo effect during being played back.

### BACKGROUND OF THE INVENTION

Unlike the past, the present world has entered into a new era with blooming technologies, and various different precision electronic products have brought tremendous convenience to our life, and thus these electronic products become a dispensable part of our life. For example, a recorder for recording sounds serves businessman by recording important conversations of each business negotiation, which is a piece of advantageous evidence if any dispute occurs in a later day. However, the structure of traditional recorders is large and heavy, and the main reason resides on that each component module is not miniaturized. Up to now, the innovation and development of integrated circuit technologies miniaturize the component modules, so that the recording equipment can be developed with a lightweight, thin, short and compact design. Since the recording equipments are miniaturized, some mobile phone manufacturers integrate the recording equipment into a mobile phone to achieve the easy-to-carry and easy-to-use purposes.

Referring to FIG. 1, a prior art recordable mobile phone 10 includes a housing 11, and the housing 11 comprises a speaker 13, a display screen 14, a plurality of press buttons 15 and a microphone 12. The foregoing components are connected by a circuit board installed in the housing 11. In a normal operating status, a user can press the press buttons 15 to produce a plurality of control signals, and these signals are sent to a processing device such as a microprocessor (MCU) installed on the circuit board and displayed on the display screen 14. These control signals correspond to texts or numbers. Further, a mobile phone user can use the microphone 12 and the speaker 13 to have two-way communications with another mobile phone user. In addition, when it is necessary to use the recording function, the user can press one of the press buttons 15 to send a recording control signal to the processing device, such that the sound received by the microphone 12 is stored into a memory installed on the circuit board and connected to the processing device to create an audio file, when the sound is processed by the processing device. Therefore, the mobile phone 10 can have the recording function, and the audio file can be played back or modified repeatedly.

However, the aforementioned design can only record mono-channel sound, which gives a low quality and a low fidelity of sound, and thus designing a stereo sound recording function for a mobile phone is an important subject that demands immediate attention.

### SUMMARY OF THE INVENTION

In view of the shortcomings of the prior art mobile phone with a recording function that uses a prior art microphone for recording sound and voice to give a mono-channel recording effect only, the inventor of the present invention based on years of practical experience to conduct extensive researches and experiments and develop a mobile phone with a stereo recording function, in hope of contributing this innovative design to the general public.

Therefore, it is a primary objective of the present invention to provide a mobile phone with a stereo recording function, which includes a mobile phone body, and the mobile phone body comprises a sound frequency processing device, and the sound frequency processing device is connected to a stereo sound frequency receiving module and a central processing unit, and the stereo sound frequency receiving module includes a plurality of sound receiving components. After these sound receiving components receive sounds from different positions within a sound field, the sounds are then converted into an audio signal, and the audio signal is sent to the sound frequency processing device and converted into a digital signal. The digital signal is sent to the central processing unit for encoding and compression. Further, the central processing unit sends the digital signal to the storage unit and saves the digital signal as an audio file. After the mobile phone or an electric device (such as a personal computer) reads the audio file, the sound can be played back with a stereo effect.

The above and other objects, features and advantages of the present invention will become apparent from the following detailed description taken with the accompanying drawings.

### BRIEF DESCRIPTION OF THE DRAWINGS

FIG. 1 is a schematic view of a prior art mobile phone with a recording function;

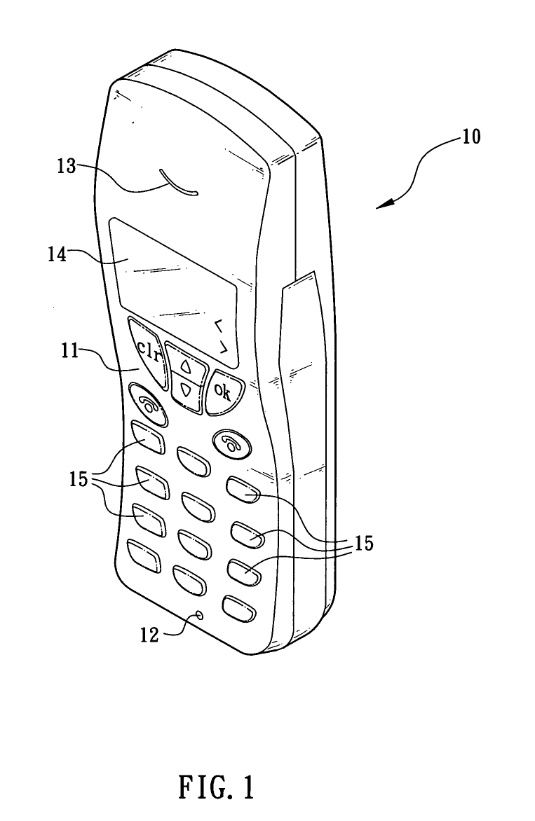

FIG. 2 is a block diagram of a stereo recording mobile phone of the present invention;

FIG. 3 is a schematic view of a mobile phone body installing two sound receiving elements disposed therein according to the present invention;

FIG. 4 is a schematic view of a mobile phone body connecting two sound receiving elements disposed externally according to the present invention; and

FIG. 5 is a schematic view of a preferred embodiment of the present invention.

### DETAILED DESCRIPTION OF THE PREFERRED EMBODIMENTS

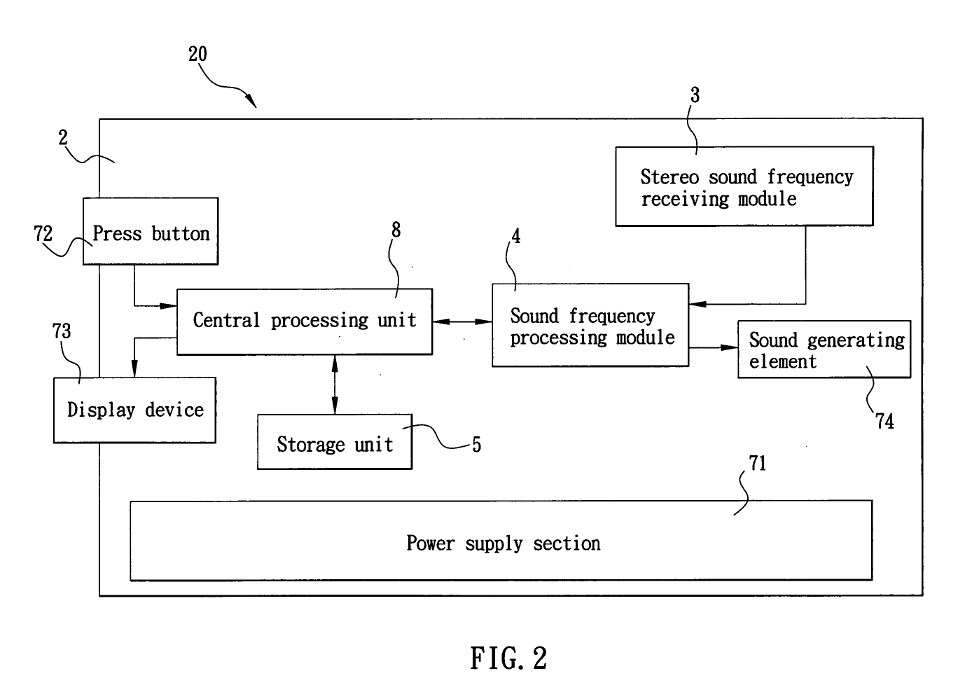

Referring to FIG. 2 for a mobile phone with a stereo recording function in accordance with the present invention, the mobile phone 20 includes a mobile phone body 2, and the mobile phone body 2 has a built-in stereo sound frequency receiving module 3, and the stereo sound frequency receiving module 3 is connected to a built-in sound frequency processing module 4 of the mobile phone body 2, and the sound frequency processing module 4 is connected to a central processing unit (CPU) 8. After the stereo sound frequency receiving module 3 has received sounds from the outside, the sounds are converted into an audio signal (which changes the physical sound waveforms into voltage waveforms), and the audio signal is sent to the sound frequency processing module 4 for encoding and sampling the audio signal, such as the action taken by an Analog/Digital Converter (ADC or A/DC), so that the audio signal can be converted into a digital signal.

Further, the sound frequency processing module 4 sends the digital signal to the central processing unit 8, and the central processing unit 8 is capable of carrying out logic computations and executions. Therefore, the central processing unit 8 can perform mathematical operations, encoding and compressions, such as the MPEG Audio Layer III (MP3) or Windows Media Audio (WMA) compression, so as to reduce the size of the digital signal and send the digital signal to a storage unit 5 and save the digital signal as an audio file in the storage unit 5. The mobile phone 20 or an electronic device, such as a Personal Computer (PC), a Personal Digital Assistant (PDA) or a digital walkman, can retrieve the audio file from the storage unit 5 to play back the sound with a stereo effect, or edit or add a sound effect to the audio file in the electronic device or mobile phone 20.

As described above, the storage unit 5 is comprised of a Random Access Memory (RAM) or a Digital Memory Card, such as a Compact Flash Card (CF Card) and a Memory Stick Card (MS Card).

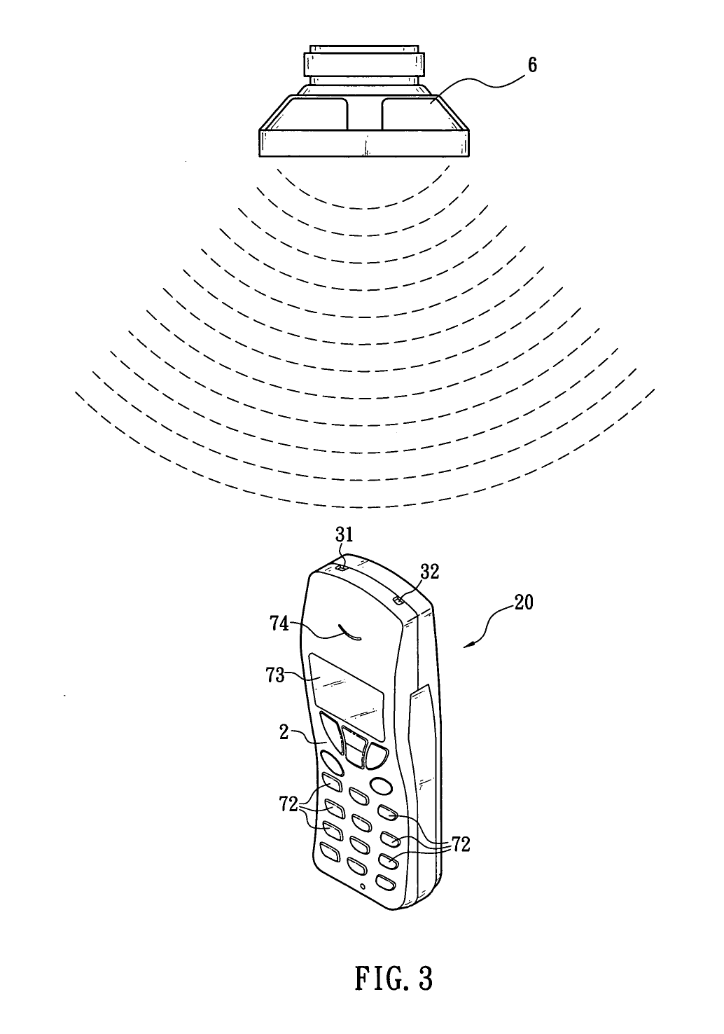

Referring to FIG. 3 for a preferred embodiment of the present invention, the stereo sound frequency receiving module 3, as shown in FIG. 2, comprises two sound receiving elements 31, 32 disposed at any two corresponding positions in the mobile phone body 2. The two sound receiving elements 31, 32 can receive sounds from the outside respectively, and the received sounds are sent to the stereo sound frequency receiving module 3 and saved as an audio file in the storage unit 5 according to the foregoing conversion process. When the audio file is played back, the sound will have a stereo effect.

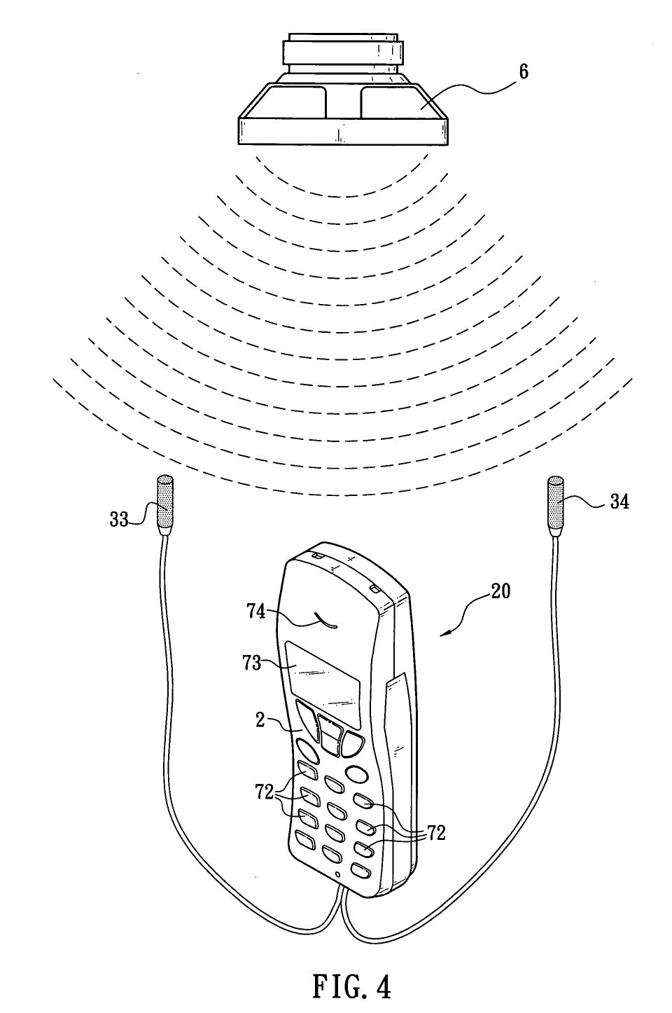

Since the sound produced by a sound source 6 can be transmitted to a certain range to define a sound field as shown in FIGS. 3 and 4, the sound listened at one position within the sound field is different from that listened at another position. Referring to FIG. 4 for another preferred embodiment of the present invention, sound receiving elements 33 and 34, such as external microphones, are installed separately at two different positions within the sound field, and the two sound receiving elements 33, 34 are connected to the stereo sound frequency receiving module 3, so that the sounds received by the two sound receiving elements 33, 34 are saved as an audio file in the storage unit 5 after being converted and processed by the stereo sound frequency receiving module 3, sound frequency processing module 4 and central processing unit 8, as shown in FIG. 2. Therefore, when the mobile phone 20 or electronic device plays back the audio file, it can produce sounds with a stereo effect just like the sounds received by the two sound receiving elements 33, 34 at two different positions.

Referring to FIG. 3 and 4 for the foregoing preferred embodiments, the sound receiving elements 31, 32, 33, 34 are comprised of Moving-Coil Microphones or Condenser Microphones. The two sound receiving elements 33, 34 and the stereo sound frequency receiving module 3 are connected by a transmission line, such as a 3-wire balance (XLR Type) line, or a wireless transmission, such as a Very High Frequency (VHF) transmission or an Ultra High Frequency (UHF).

Referring to FIG. 2 again for the foregoing embodiments, the mobile phone body 2 includes a power supply section 71, and the power supply section 71 transmits its electric power to each component module in the mobile phone body 2, so that each component module can have the power for its normal operation, and the power supply section 71 includes at least one battery or a transformer for converting the city electricity (110V or 220V) into the power required for the component modules inside the mobile phone body 2, and a power line is used to connect the power supply section 71 for supplying the electric power into the mobile phone body 2.

Referring to FIGS. 2, 3 and 4, the mobile phone body 2 has a plurality of press buttons 72 disposed on its surface, and the press buttons 72 are connected to the central processing unit 8, such that after one of the press buttons 72 is pressed, a corresponding control signal is produced. The control signal is sent to the central processing unit 8 for controlling the mobile phone 20 to make a call, receive a call, or input data. Further, the mobile phone body 2 includes a display device 73, such as a Liquid Crystal Display (LCD) thereon. The display device 73 is connected to the central processing unit 8, so that after a user presses a press button 72, the telephone number or data inputted by the user will be displayed on the display device 73, and the user can verify whether or not the inputted data is correct.

Referring to FIG. 2, the mobile phone body 2 further includes a sound producing element 74 which is controlled by the sound frequency processing module 4, such that when the central processing unit 8 retrieves the audio file from the storage unit 5, the audio signal is converted into another digital signal and such digital signal is sent to the sound frequency processing module 4 for being decoded and sampled. This action is similar to the one taken by the Digital/Analog Converter (ADC or A/DC), and the digital signal is then converted into another audio signal, and the sound producing element 74 converts such audio signal into another sound (very close to the sounds received by the sound receiving elements 31, 32 or 33, 34 as shown in FIGS. 3 and 4), and then the another sound is played back. The sound producing element 74 and the sound receiving elements 31, 32 or 33, 34 are used to provide two-way communications with another mobile phone user.

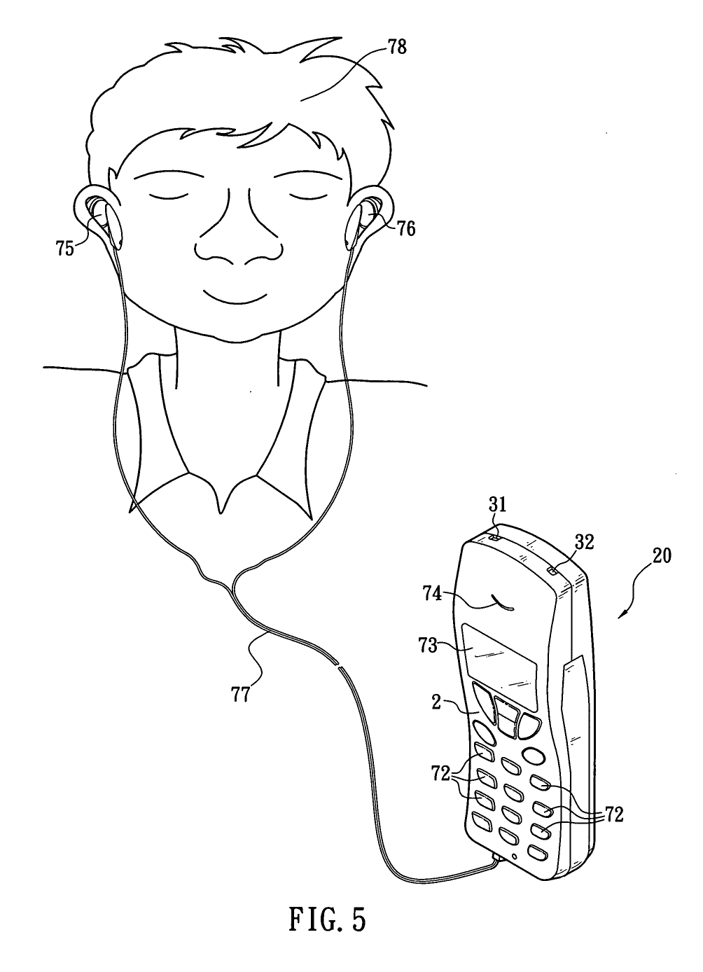

Referring to FIG. 5, the mobile phone body 2 installs two external sound producing elements 75, 76, and the two sound producing elements 75, 76 are connected to the sound frequency processing module 4 (as shown in FIG. 2) and installed on two corresponding sides of a user 78, such that when the central processing unit 8 as shown in FIG. 2 converts the audio file into another digital signal, the central processing unit 8 sends the another digital signal to the sound frequency processing module 4, and the sound frequency processing module 4 decodes and samples the another digital signal and converts the another digital signal into another audio signal. The two sound producing elements 75, 76 convert the another audio signal into another sound and play back that sound. Since the two sound producing elements 75, 76 correspond to the sounds separately received by the two sound receiving elements 31, 32 (or 33, 34), therefore the sound played back by the sound producing elements 75, 76 can have a stereo effect.

Referring to FIGS. 2 and 5, the sound producing elements 74, 75, 76, as shown in FIGS. 3 and 4, are earphones or antimagnetic speakers, and the two sound producing elements 75, 76 are connected to the sound frequency processing module 4 by a transmission line 77, such as a Fiber Cable or a Silver Ribbon, or a wireless transmission, such as a Bluetooth transmission or an Infrared Rays (IR) transmission.

While the invention herein disclosed has been described by means of specific embodiments, numerous modifications and variations could be made thereto by those skilled in the art without departing from the scope and spirit of the invention set forth in the claims.

What is claimed is:

1. A mobile phone with a stereo recording function, comprising:
a mobile phone body;
a central processing unit, disposed inside said mobile phone body;
a stereo sound frequency receiving module, disposed inside said mobile phone body and coupled to said central processing unit, and capable of converting a sound into an audio signal; and
a sound frequency processing module, disposed inside said mobile phone body and coupled to said stereo sound frequency receiving module and said central processing unit, and capable of converting said audio signal into a digital signal and sending said digital signal to said central processing unit for encoding and compression.

2. The mobile phone of claim 1 further comprising a storage unit disposed inside said mobile phone body and coupled to said central processing unit for storing said digital signal sent from said central processing unit as an audio file.

3. The mobile phone of claim 2, wherein said storage unit is a random access memory.

4. The mobile phone of claim 1, wherein said stereo sound frequency receiving module comprises at least two sound receiving elements for receiving sounds outside said mobile phone body.

5. The mobile phone of claim 4, wherein said sound receiving element is installed inside said mobile phone body.

6. The mobile phone of claim 4, wherein said sound receiving element is installed outside said mobile phone body.

7. The mobile phone of claim 4, wherein said sound receiving element is a condenser microphone.

8. The mobile phone of claim 6, wherein said sound receiving element is connected to said stereo sound frequency receiving module through a wireless transmission.

9. The mobile phone of claim 1, wherein said mobile phone body includes a power supply section for supplying electric power to each component module installed inside said mobile phone body, and enabling said each component module to be operated normally.

10. The mobile phone of claim 1, wherein said mobile phone body comprises a plurality of press buttons disposed on its surface and coupled with said central processing unit, such that after said each press button is pressed, a corresponding control signal is produced and said control signal is sent to said central processing unit.

11. The mobile phone of claim 1, wherein said mobile phone body comprises a display device disposed thereon and coupled with said central processing unit.

12. The mobile phone of claim 1, wherein said mobile phone body comprises at least one sound producing element coupled with said sound frequency processing module for playing back sounds.

13. The mobile phone of claim 12, wherein said sound producing element is disposed inside said mobile phone body.

14. The mobile phone of claim 12, wherein said sound producing element is disposed outside said mobile phone body.

15. The mobile phone of claim 12, wherein said sound producing element is an earphone.

16. The mobile phone of claim 14, wherein said sound producing element is coupled to said sound frequency processing module through a transmission line.

17. The mobile phone of claim 14, wherein said sound producing element is coupled to said sound frequency processing module through a wireless transmission.

18. The mobile phone of claim 17, wherein said wireless transmission is a Bluetooth transmission.

19. The mobile phone of claim 17, wherein said wireless transmission is an infrared ray transmission.
